(19) United States
(12) Patent Application Publication
(10) Pub. No.: US 2016/0105620 A1
(43) Pub. Date: Apr. 14, 2016

(54) METHODS, APPARATUS, AND TERMINAL DEVICES OF IMAGE PROCESSING

(71) Applicant: TENCENT TECHNOLOGY (SHENZHEN) COMPANY LIMITED, Shenzhen (CN)

(72) Inventors: ZHU LIANG, Shenzhen (CN); DING MA, Shenzhen (CN); XIAOYI LI, Shenzhen (CN); ZHENHAI WU, Shenzhen (CN)

(21) Appl. No.: 14/974,263

(22) Filed: Dec. 18, 2015

Related U.S. Application Data
(63) Continuation of application No. PCT/CN2014/079347, filed on Jun. 6, 2014.

(30) Foreign Application Priority Data
Jun. 18, 2013 (CN) 2013-10242581.5

(51) Int. Cl. H04N 5/272; G10L 15/26; H04N 5/232

(52) U.S. Cl. CPC H04N 5/272; H04N 5/23293; G10L 15/265; H04N 2101/00

(57) ABSTRACT

Methods, apparatuses, and terminal devices of processing an image are provided. A region for superimposing audio related information is preset on a capturing interface in a terminal device. The obtained audio related information is superimposed onto the region. And a captured image superimposed with the audio related information is outputted, so that the image captured at the terminal device can display various types of information on the captured image. By publishing the image containing the audio related information, friends of the user can feel the environment of where the user is located in combination with the image.

### CROSS-REFERENCES TO RELATED APPLICATIONS

This application is a continuation application of PCT Patent Application No. PCT/CN2014/079347, filed on Jun. 6, 2014, which claims priority to Chinese Patent Application No. 201310242581.5, filed on Jun. 18, 2013, the entire content of all of which is incorporated herein by reference.

### FIELD OF THE DISCLOSURE

The present disclosure generally relates to the field of image processing and, more particularly, relates to methods, apparatuses, and terminal devices of image processing.

### BACKGROUND

Currently, many terminal devices (such as mobile phones) can capture images via a capturing unit (such as a camera). Time information (e.g., captured at X hour X minute) can often be displayed on a capturing interface of the mobile terminal device. After the capturing unit captures an image, a captured image superimposed with time information can be obtained immediately. However, current terminal devices can only provide time information on the capturing interface.

### BRIEF SUMMARY OF THE DISCLOSURE

According to various embodiments, there is provided an image processing method. In the method, an operation instruction for a multimedia capturing application is received in a terminal device from a user; and in response to the operation instruction, an image is captured via a capturing unit in the terminal device; and a region is preset on a capturing interface for superimposing audio related information. Audio signal of a song is obtained from an external environment via an audio-signal obtaining unit in the terminal device; and the audio related information of the song is obtained according to the audio signal. A superimposing instruction inputted by the user is detected; and in response to the superimposing instruction, the obtained audio related information is superimposed onto the preset region on the capturing interface. A capturing instruction inputted by the user is detected; and in response to the capturing instruction, a captured image superimposed with the audio related information is outputted.

According to various embodiments, there is provided an image processing apparatus. The image processing apparatus includes a superimposing-region presetting unit, an obtaining unit, a superimposing unit, and a captured-image outputting unit. The superimposing-region presetting unit is configured to receive an operation instruction for a multimedia capturing application in a terminal device from a user; and in response to the operation instruction, to capture an image via a capturing unit in the terminal device; and to preset a region on a capturing interface for superimposing audio related information. The obtaining unit is configured, after the presetting by the superimposing-region presetting unit, to obtain audio signal of a song from an external environment via an audio-signal obtaining unit in the terminal device; and to obtain the audio related information of the song according to the audio signal. The superimposing unit is configured to detect a superimposing instruction inputted by the user; and in response to the superimposing instruction, to superimpose the audio related information obtained by obtaining unit onto the preset region preset by the superimposing-region presetting unit. And the captured-image outputting unit is configured to detect a capturing instruction inputted by the user; and in response to the capturing instruction, to output a captured image superimposed with the audio related information by the superimposing unit.

According to various embodiments, there is provided a non-transitory computer-readable medium having computer program. When being executed by a processor, the computer program performs an image processing method. The method includes receiving an operation instruction for a multimedia capturing application in a terminal device from a user, in response to the operation instruction, capturing an image via a capturing unit in the terminal device, and presetting a region on a capturing interface for superimposing audio related information; obtaining audio signal of a song from an external environment via an audio-signal obtaining unit in the terminal device, and obtaining the audio related information of the song according to the audio signal; detecting a superimposing instruction inputted by the user, and in response to the superimposing instruction, superimposing the obtained audio related information onto the preset region on the capturing interface; and detecting a capturing instruction inputted by the user, and in response to the capturing instruction, outputting a captured image superimposed with the audio related information.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method of image processing consistent with various disclosed embodiments;

FIG. 2 depicts an effect after superimposing audio related information via a watermark algorithm consistent with various disclosed embodiments;

FIG. 3 depicts an exemplary apparatus of image processing consistent with various disclosed embodiments;

FIG. 4 depicts an exemplary terminal device of image processing consistent with various disclosed embodiments;

FIG. 5 depicts an exemplary environment incorporating certain disclosed embodiments; and

FIG. 6 depicts an exemplary terminal device consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

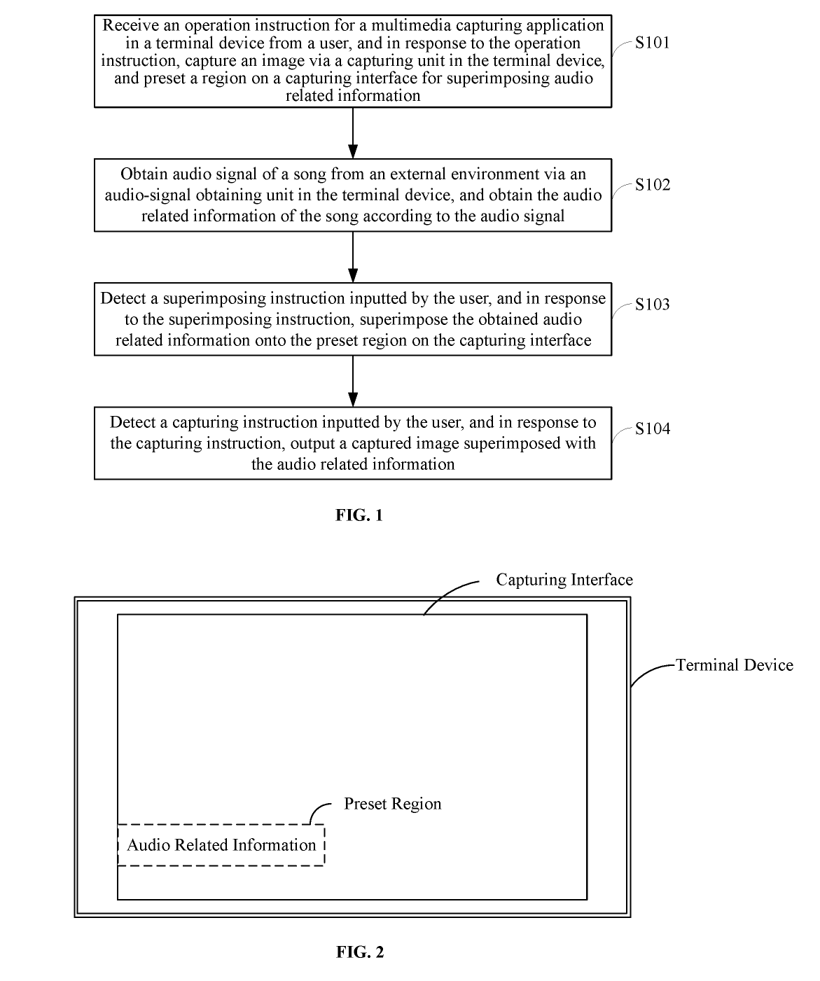

FIGS. 1-4 depict exemplary image processing methods, apparatus, and terminal devices. The exemplary methods, apparatus, and terminal devices can be implemented, for example, in an exemplary environment 500 as shown in FIG. 5.

As shown in FIG. 5, the environment 500 can include a server 504, a terminal 506, and a communication network 502. The server 504 and the terminal 506 may be coupled through the communication network 502 for information exchange, for example, Internet searching, webpage browsing, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless.

A terminal, as used herein, may refer to any appropriate user terminal device with certain computing capabilities including, for example, a personal computer (PC), a work station computer, a notebook computer, a car-carrying computer (e.g., carried in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably.

A server, as used herein, may refer one or more server computers configured to provide certain server functionalities including, for example, search engines and database management. A server may also include one or more processors to execute computer programs in parallel.

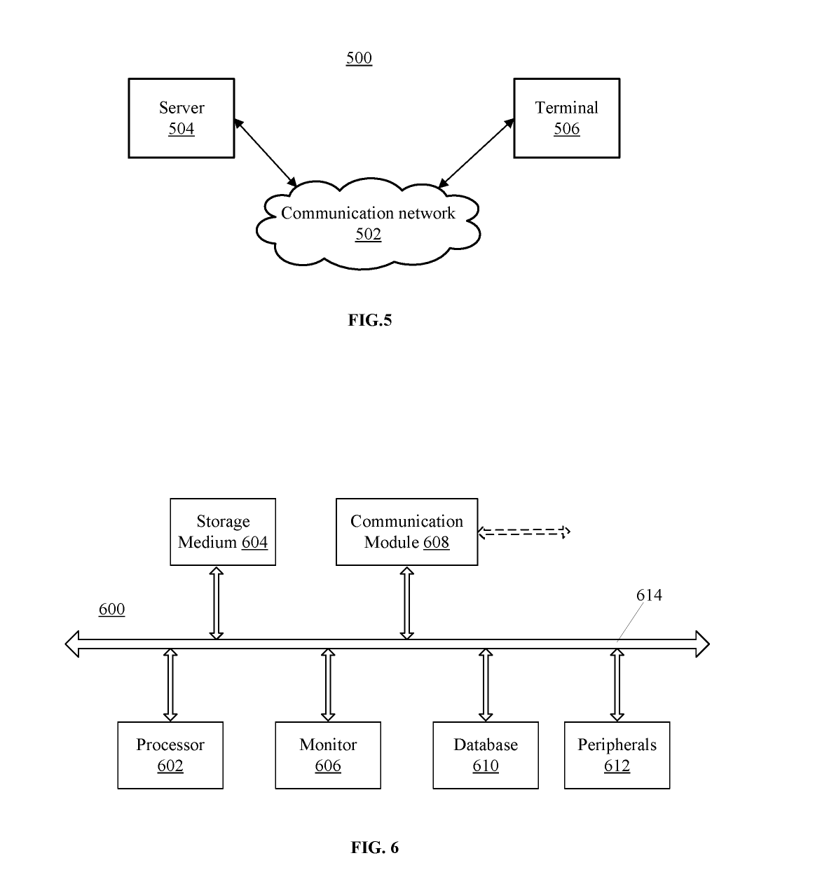

The server 504 and the terminal 506 may be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, a storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, for example, ROM, RAM, and flash memory modules, and mass storages, for example, CD-ROM, U-disk, removable hard disk, etc. The storage medium 604 may store computer programs for implementing various processes, when executed by the processor 602.

Further, the peripherals 612 may include I/O devices, for example, keyboard and mouse, and the communication module 608 may include network devices for establishing connections through the communication network 502. The database 610 may include one or more databases for storing certain data and for performing certain operations on the stored data, for example, webpage browsing, database searching, etc.

In operation, the terminal 506 may cause the server 504 to perform certain actions, for example, an Internet search or other database operations. The server 504 may be configured to provide structures and functions for such actions and operations. More particularly, the server 504 may include a data searching system for real-time database searching. In various embodiments, a terminal, for example, a mobile terminal involved in the disclosed methods and systems can include the terminal 506.

As disclosed herein, a region for subsequently superimposing audio related information thereon is preset on a capturing interface in a terminal device. The audio related information is superimposed onto the region on the capturing interface. And a captured image superimposed with the audio related information is outputted, so that the image captured at the terminal device can display various types of information. By publishing the image containing the audio related information, a receiver of the image (e.g. a friend of the user publishing the image) can obtain related audio environment from the published image, so that the receiver obtains comprehensive image information and feels the audio environment of where the user is located in combination with the image.

FIG. 1 depicts an exemplary method of image processing consistent with various disclosed embodiments.

In Step S101, an operation instruction for a multimedia capturing application in a terminal device is received from a user. In response to the operation instruction, an image is captured via a capturing unit in the terminal device. And a region on a capturing interface is preset for superimposing audio related information.

In one embodiment, the terminal device receives the operation instruction for the multimedia capturing application (e.g., a camera application) from the user first. In response to the operation instruction, the capturing unit is triggered to capture the image. The terminal device presets the region for superimposing audio related information on the capturing interface for capturing the image. The audio related information can be obtained via internet by the user, or can be obtained by analyzing the audio signal obtained via the terminal device by the user.

In Step S102, audio signal of a song is obtained from an external environment via an audio-signal obtaining unit in the terminal device. And the audio related information of the song is obtained according to the audio signal. In one embodiment, the audio related information of the song includes one or more of a song name, a singer name, an audio length, and an audio bit rate of song(s) in an album containing the song.

The terminal device uses the audio-signal obtaining unit (e.g., a microphone) to obtain the audio signal being played in the external environment (e.g. a song being played in a video store). The audio signal can be compared with the audio signal data saved in a database (the database can be a database (e.g., with a small size) stored in the terminal device, or can be database (e.g., with a large size) stored on a server connected with the terminal device) to obtain the audio related information corresponding to the audio signal.

It should be noted that the audio related information also includes the audio related information of an audio saved locally in the terminal device and played by the terminal device through a speaker (e.g., a built-in speaker of the terminal device, or an external speaker of the terminal device). Because the audio being played by the terminal device is an audio saved locally in the terminal device, the terminal device can obtain the audio related information of the audio directly without obtaining the audio signal first and then comparing the audio signal with the data in the database.

In Step S103, a superimposing instruction inputted by the user is detected. And in response to the superimposing instruction, the obtained audio related information is superimposed onto the preset region on the capturing interface.

In one embodiment, after the terminal device triggers the capturing unit, the capturing interface of the capturing unit can be displayed on the terminal device. The user can adjust the image captured by the capturing unit on the capturing interface. The user can superimpose obtained audio related information onto the preset region on the capturing interface through operations including, e.g., mouse and keyboard operations, and/or touch operations on a touch screen. In various embodiments, the step of superimposing the obtained audio related information onto the region on the capturing interface includes the following exemplary steps.

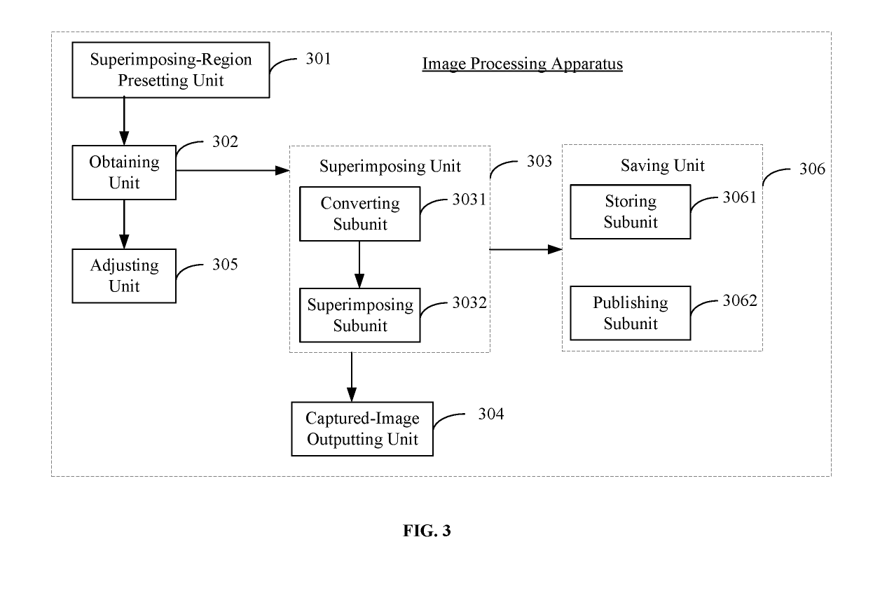

The audio related information is converted into an image. The terminal device first converts format of the audio related information into an image format, e.g., having a PDF format, a JPG format, or other suitable format for images, via converting software products. The image (having the image format) is superimposed onto the region on the capturing interface according to, e.g., a watermark algorithm. For example, FIG. 2 depicts an effect after using a watermark algorithm to superimpose audio related information consistent with various disclosed embodiments.

In Step S104, a capturing instruction inputted by the user is detected. And in response to the capturing instruction, a captured image superimposed with the audio related information is outputted.

In one embodiment, after the superimposing of the audio related information onto the preset region on the capturing interface in the terminal device, the terminal device first detects whether the user has inputted a capturing instruction. When the capturing instruction has been inputted, the terminal device can respond to the capturing instruction. As a result of the response, the captured image superimposed with the audio related information is outputted.

In various embodiments, a region for superimposing audio related information is preset on a capturing interface in a terminal device. The obtained audio related information is superimposed onto the region. And a captured image superimposed with the audio related information is outputted, so that the image captured at the terminal device can display various types of information. By publishing the image containing the audio related information, friends of the user can feel the environment of where the user is located in combination with the image.

In an optional embodiment, after the obtaining of the audio related information, the method further includes: adjusting format of the audio related information into a preset format for displaying.

For example, after the obtaining of the audio related information, the format of the audio related information can be adjusted according to the preset displaying format.

In one embodiment, the audio related information obtained by the terminal device may include: an album name containing the song, and a song name, a singer name, an audio length, and an audio bit rate of song(s) in the album containing the song. In this case, the terminal device can, according to the preset format for displaying, adjust the format of the audio related information into only-displaying the song name, the singer name, and the audio length. Further, the displaying order of the audio related information can be adjusted, e.g., the displaying order of the audio related information can be adjusted to: the audio length, the singer name, and the song name.

In another optional embodiment, after the superimposing of the obtained audio related information onto the region on the capturing interface, the method further includes saving the captured image superimposed with the audio related information.

For example, after the terminal device superimposes the audio related information onto the preset region on the capturing interface, the terminal device can also save the image superimposed with audio related information. The step of saving of the captured image superimposed with the audio related information includes the following exemplary steps. The captured image superimposed with the audio related information is saved in the terminal device. Alternatively, an image publishing instruction inputted by the user is received. And in response to the image publishing instruction, the captured image superimposed with the audio related information is sent to a third party application for publishing. The third party application is related to the multimedia capturing application.

In one embodiment, conventional methods for saving the image in the terminal device can be used. In various embodiments, the image can be published to the third party application related to the multimedia capturing application, so as to facilitate the user to share images with friends via the third party application.

FIG. 3 depicts an exemplary apparatus of image processing consistent with various disclosed embodiments. For illustration purpose, only certain portions are discussed for the exemplary apparatus, although other related information (e.g., according to embodiments depicted in FIGS. 1-2) may be encompassed in the present disclosure. The exemplary apparatus can include a superimposing-region presetting unit 301, an obtaining unit 302, a superimposing unit 303, and/or a captured-image outputting unit 304.

The superimposing-region presetting unit 301 is configured to receive an operation instruction for a multimedia capturing application in a terminal device from a user, and in response to the operation instruction, to capture an image via a capturing unit in the terminal device, and to preset a region on a capturing interface for subsequently superimposing audio related information.

The superimposing-region presetting unit 301 receives the operation instruction for the multimedia capturing application (e.g., a camera application) from the user first. In response to the operation instruction, the capturing unit is triggered to capture the image. The terminal device presets the region for superimposing audio related information on the capturing interface for capturing the image. The audio related information can be obtained via internet by the user, or can be obtained by analyzing the audio signal obtained via the terminal device by the user.

The obtaining unit 302 is configured to, after the presetting the region by the superimposing-region presetting unit 301, obtain audio signal from an external environment via an audio-signal obtaining unit in the terminal device, and to obtain the audio related information according to the audio signal.

In one embodiment, the obtaining unit 302 uses the audio-signal obtaining unit (e.g. a microphone) to obtain the audio signal being played in the external environment (e.g. a song being played in a video store). The audio signal can be compared with the audio signal data saved in a database (the database can be a small database in the terminal device, or can be a large database in a server connected with the terminal device), so as to obtain the audio related information corresponding to the audio signal.

It should be noted that the audio related information also includes the audio related information of an audio saved locally in the terminal device and played by the terminal device through a speaker (e.g., a built-in speaker of the terminal device, or an external speaker of the terminal device). Because the audio being played by the terminal device is an audio saved locally in the terminal device, the terminal device can obtain the audio related information of the audio directly without obtaining the audio signal first and then comparing the audio signal with the data in the database.

The superimposing unit 303 is configured to detect a superimposing instruction inputted by the user, and in response to the superimposing instruction, and to superimpose the audio related information obtained by obtaining unit 302 onto the preset region preset by the superimposing-region presetting unit 301.

In one embodiment, after the terminal device triggers the capturing unit, the capturing interface of the capturing unit can be displayed on the terminal device. The user can adjust the image captured by the capturing unit on the capturing interface. The user can superimpose obtained audio related information onto the preset region on the capturing interface through operations including, e.g., mouse and keyboard operations, and/or touch operations on a touch screen.

The superimposing unit 303 includes a converting subunit 3031 and/or a superimposing subunit 3032.

The converting subunit 3031 is configured to convert the audio related information into an image.

The terminal device first converts format of the audio related information into an image format, e.g., having a PDF format, a JPG format, or other suitable format for images, via converting software products. The superimposing unit 3032 is configured to superimpose the image converted by the converting subunit 3031 onto the preset region on the capturing interface according to, e.g., a watermark algorithm.

The captured-image outputting unit 304 is configured to detect a capturing instruction inputted by the user, and in response to the capturing instruction, to output a captured image superimposed with the audio related information by the superimposing unit 303.

In one embodiment, after the superimposing of the audio related information onto the preset region on the capturing interface in the terminal device, the terminal device first detects whether the user has inputted a capturing instruction. When the capturing instruction has been inputted, the terminal device can respond to the capturing instruction. As a result of the response, the captured image superimposed with the audio related information is outputted.

In various embodiments, a region for superimposing audio related information is preset on a capturing interface in a terminal device. The obtained audio related information is superimposed onto the region. And a captured image superimposed with the audio related information is outputted, so that the image captured at the terminal device can display various types of information. By publishing the image containing the audio related information, friends of the user can feel the environment of where the user is located in combination with the image.

In an optional embodiment, after the obtaining step performed by the obtaining unit 302, the apparatus further includes an adjusting unit 305.

The adjusting unit 305 is configured to adjust a format of the audio related information obtained by the obtaining unit 302 into a preset displaying format (or format for displaying).

For example, after the obtaining of the audio related information, the adjusting unit 305 can adjust the format of the audio related information according to the preset displaying format.

In one embodiment, the audio related information obtained by the terminal device may include: an album name containing the song, and a song name, a singer name, an audio length, and an audio bit rate of song(s) in the album containing the song. In this case, the terminal device can, according to the preset format for displaying, adjust the format of the audio related information into only-displaying the song name, the singer name, and the audio length. Further, the displaying order of the audio related information can be adjusted, e.g., the displaying order of the audio related information can be adjusted to: the audio length, the singer name, and the song name.

In another optional embodiment, after the superimposing step performed by the superimposing unit 303, the apparatus further includes a saving unit 306.

The saving unit 306 is configured to save the captured image superimposed with the audio related information by the superimposing unit 303.

In one embodiment, after the terminal device superimposes the audio related information onto the preset region on the capturing interface, the terminal device can also save the image superimposed with audio related information. The saving unit 306 includes a storing subunit 3061 and/or a publishing subunit 3062.

The storing subunit 3061 is configured to save the captured image superimposed with the audio related information in the terminal device. The publishing subunit 3062 is configured to receive an image publishing instruction inputted by the user, and in response to the image publishing instruction, to send the captured image superimposed with the audio information to a third party application for publishing. The third party application is related to the multimedia capturing application.

In one embodiment, conventional methods for saving the image in the terminal device can be used. In various embodiments, the image can be published to the third party application related to the multimedia capturing application, so as to facilitate the user to share images with friends via the third party application.

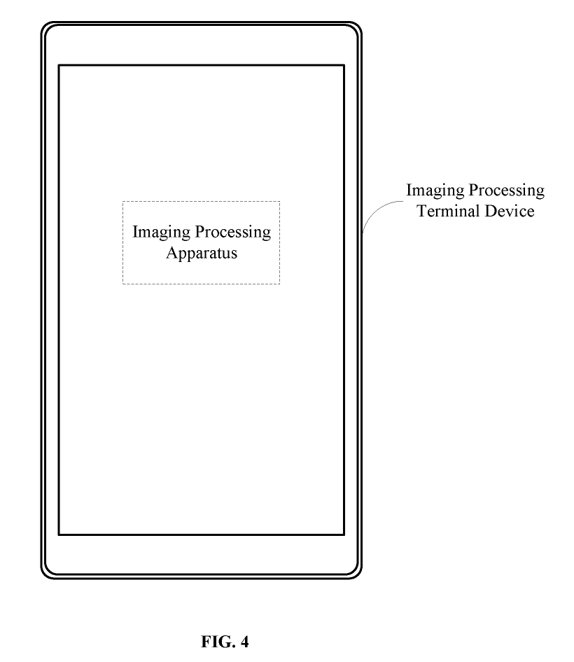

FIG. 4 depicts an exemplary terminal device of image processing consistent with various disclosed embodiments. The terminal device depicted in FIG. 4 includes the image processing apparatus depicted in FIG. 3. By implementing the terminal device depicted in FIG. 4, the user can dynamically modify additional information of a template floatingly displayed on the capturing interface, to meet the requirement of the user to modify the additional information of the template floatingly displayed on the capturing interface.

In a certain embodiment, when a user takes a picture by a mobile phone, an acoustic wave sensor built in the mobile phone can be used to convert a song into image(s) and/or text, which can then be superimposed onto the picture. For example, acoustic fingerprint technology can be used to extract a digital abstract from the audio signal by an algorithm. The digital abstract can be used for recognizing an audio sample and/or for quickly positioning similar audio information in an audio database.

In a specific embodiment, a song collection process and an image capturing process can be performed and superimposed together. When capturing an image (or taking a picture), audio information, such as noises or a song information, can be recorded from the external environment. Such song information can be realized by visual images and/or text, which can then be synchronizedly superimposed onto the captured image (or the picture taken). In this manner, the captured image can be overlaid with environmental audio information.

In an exemplary process, when activating or starting a camera of a mobile phone, audio information from external environment can always be received by a microphone in the mobile phone and be continuously collected. For example, after a camera viewfinder is opened, audio data collection can be started.

Acoustic fingerprint technology can be used for acoustic fingerprint matching and acoustic fingerprint extraction. The collected audio data can be calculated in accordance with a fingerprint feature extraction algorithm to obtain audio features, which can then be compared with a large number of audio fingerprints stored in an audio database for identification. When an original fingerprint is identified, corresponding metadata information can be extracted and sent back to the user.

Image and text information contained in the metadata can be returned and displayed on a camera screen (e.g., on a capturing interface). For example, a name of an album containing the song, a cover of the album, singer information, an issuing time of the album, etc. can be statically superimposed on the viewfinder box. In addition, real-time song lyrics information obtained from a dynamic comparison of acoustic fingerprints of the song can be dynamically superimposed on the viewfinder box as the song is progressedly played. When the song has finished playing, song lyrics information can be frozen and displayed on the viewfinder box.

The image and text information can be frozen and superimposed on a captured image. For example, when a user clicks on a “capture” button to capture an image, collection of audio information (e.g., sound acquisition) from external environment can be simultaneously stopped. Image and text information of the song lastly returned prior to the “capturing” action can be recorded. When being “frozen” on the captured image and being locally saved, such image and text information can be converted into an image format and be superimposed on the captured image (or picture). Further, when saving the captured image/picture, position coordinates, resolution, and/or other information of the converted image (format) on the captured image can be saved together into an information file of the captured image/picture.

It should be noted that, in the present disclosure each embodiment is progressively described, i.e., each embodiment is described and focused on difference between embodiments. Similar and/or the same portions between various embodiments can be referred to with each other. In addition, exemplary apparatus (e.g., a server) is described with respect to corresponding methods.

The disclosed methods, and/or apparatus can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The apparatus, devices, and/or methods can be implemented in a software manner. Of course, the apparatus, devices, and/or methods can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a ” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the disclosed methods, apparatus, and terminal devices, a region for superimposing audio related information is preset on a capturing interface in a terminal device. The obtained audio related information is superimposed onto the region. And a captured image superimposed with the audio related information is outputted, so that the image captured at the terminal device can display various types of information. For example, by publishing the image containing the audio related information, friends of the user can feel the environment of where the user is located in combination with the image.

What is claimed is:

1. An image processing method, comprising:
receiving an operation instruction for a multimedia capturing application in a terminal device from a user, in response to the operation instruction, capturing an image via a capturing unit in the terminal device, and presetting a region on a capturing interface for superimposing audio related information;
obtaining audio signal of a song from an external environment via an audio-signal obtaining unit in the terminal device, and obtaining the audio related information of the song according to the audio signal;
detecting a superimposing instruction inputted by the user, and in response to the superimposing instruction, superimposing the obtained audio related information onto the preset region on the capturing interface; and
detecting a capturing instruction inputted by the user, and in response to the capturing instruction, outputting a captured image superimposed with the audio related information.

2. The method according to claim 1, wherein, after the obtaining of the audio related information of the song, the method further comprises:
adjusting a format of the audio related information into a preset displaying format.

3. The method according to claim 1, wherein, after the superimposing of the obtained audio related information onto the region on the capturing interface, the method further comprises:
saving the captured image superimposed with the audio related information.

4. The method according to claim 3, wherein the saving of the captured image superimposed with the audio related information comprises:
saving the captured image superimposed with the audio related information in the terminal device; or
receiving an image publishing instruction inputted by the user, and in response to the image publishing instruction, sending the captured image superimposed with the audio related information to a third party application for publishing, wherein the third party application is related to the multimedia capturing application.

5. The method according to claim 4, wherein the superimposing of the obtained audio related information onto the region on the capturing interface comprises:
converting the audio related information into an image; and
superimposing the image onto the preset region according to a watermark algorithm.

6. The method according to claim 4, wherein, when the audio signal is an audio played by a speaker of the terminal device, the obtaining of the audio related information according to the audio signal comprises:
obtaining the audio related information via searching local data of the terminal device; or
obtaining the audio related information via interne.

7. The method according to claim 1, wherein the audio related information of the song comprises one or more of a song name, a singer name, an audio length, and an audio bit rate that are of one or more songs in an album containing the song.

8. An image processing apparatus, comprising:
a superimposing-region presetting unit, configured to receive an operation instruction for a multimedia capturing application in a terminal device from a user, and in response to the operation instruction, to capture an image via a capturing unit in the terminal device, and preset a region on a capturing interface for superimposing audio related information;
an obtaining unit, configured to, after the presetting by the superimposing-region presetting unit, obtain audio signal of a song from an external environment via an audio-signal obtaining unit in the terminal device, and to obtain the audio related information of the song according to the audio signal;
a superimposing unit, configured to detect a superimposing instruction inputted by the user, and in response to the superimposing instruction, to superimpose the audio related information obtained by obtaining unit onto the preset region preset by the superimposing-region presetting unit; and
a captured-image outputting unit, configured to detect a capturing instruction inputted by the user, and in response to the capturing instruction, to output a captured image superimposed with the audio related information by the superimposing unit.

9. The apparatus according to claim 8, further comprising:
an adjusting unit, configured to adjust a format of the audio related information obtained by the obtaining unit into a preset displaying format.

10. The apparatus according to claim 8, further comprising:
a saving unit, configured to save the captured image superimposed with the audio related information by the superimposing unit.

11. The apparatus according to claim 10, wherein the saving unit comprises:
a storing subunit, configured to store the captured image superimposed with the audio related information in the terminal device; or
a publishing subunit, configured to receive an image publishing instruction inputted by the user, and in response to the image publishing instruction, to send the captured image superimposed with the audio information to a third party application for publishing; wherein, the third party application is related to the multimedia capturing application.

12. The apparatus according to claim 11, wherein the superimposing unit comprises:
a converting subunit, configured to convert the audio related information into an image; and
a superimposing subunit, configured to superimpose the image converted by the converting subunit onto the preset region according to a watermark algorithm.

13. The apparatus according to claim 11, wherein, when the audio signal obtained by the obtaining unit is an audio played by a speaker of the terminal device, the obtaining unit is further configured:
to obtain the audio related information via searching local data of the terminal device; or
to obtain the audio related information transmitted via internet.

14. The apparatus according to claim 8, wherein the audio related information of the song comprises one or more of a song name, a singer name, an audio length, and an audio bit rate that are of one or more songs in an album containing the song.

15. A non-transitory computer-readable medium having computer program for, when being executed by a processor, performing an image processing method, the method comprising:
receiving an operation instruction for a multimedia capturing application in a terminal device from a user, in response to the operation instruction, capturing an image via a capturing unit in the terminal device, and presetting a region on a capturing interface for superimposing audio related information;
obtaining audio signal of a song from an external environment via an audio-signal obtaining unit in the terminal device, and obtaining the audio related information of the song according to the audio signal;
detecting a superimposing instruction inputted by the user, and in response to the superimposing instruction, superimposing the obtained audio related information onto the preset region on the capturing interface; and
detecting a capturing instruction inputted by the user, and in response to the capturing instruction, outputting a captured image superimposed with the audio related information.

16. The non-transitory computer-readable medium according to claim 15, wherein, after the obtaining of the audio related information of the song, the method further comprises:
adjusting a format of the audio related information into a preset displaying format.

17. The non-transitory computer-readable medium according to claim 15, wherein, after the superimposing of the obtained audio related information onto the region on the capturing interface, the method further comprises:
saving the captured image superimposed with the audio related information.

18. The method according to claim 3, wherein the saving of the captured image superimposed with the audio related information comprises:
saving the captured image superimposed with the audio related information in the terminal device; or
receiving an image publishing instruction inputted by the user, and in response to the image publishing instruction, sending the captured image superimposed with the audio related information to a third party application for publishing, wherein the third party application is related to the multimedia capturing application.

19. The non-transitory computer-readable medium according to claim 18, wherein the superimposing of the obtained audio related information onto the region on the capturing interface comprises:
converting the audio related information into an image; and
superimposing the image onto the preset region according to a watermark algorithm.

20. The non-transitory computer-readable medium according to claim 18, wherein, when the audio signal is an audio played by a speaker of the terminal device, the obtaining of the audio related information according to the audio signal comprises:
obtaining the audio related information via searching local data of the terminal device; or
obtaining the audio related information via internet.
